(19) United States
(12) Patent Application Publication
(10) Pub. No.: US 2022/0237675 A1
(43) Pub. Date: Jul. 28, 2022

(54) MANAGING ONLINE ORDER ITEM QUANTITIES

(71) Applicant: DOORDASH, INC., San Francisco, CA (US)

(72) Inventor: Jeffrey William MONTAGUE, San Francisco, CA (US)

(21) Appl. No.: 15/858,742

(22) Filed: Dec. 29, 2017

(51) Int. Cl. G06Q 30/06

(52) U.S. Cl. CPC G06Q 30/0621; G06Q 30/0633; G06Q 30/0643

(57) ABSTRACT

In some examples, a computer may receive item information indicating items offered by a plurality of merchants. The item information may indicate a number of servings provided by each item. The computer may receive, from a buyer device, an indication of a quantity of people to be served for an order and an indication of a selection of one or more of the items. The computer may determine, from the item information, the number of servings for each selected item. The computer may send, to the buyer device, user interface information to cause the buyer device to present a graphic indicator including a graphical representation of each selected item based on the number of servings of the selected item relative to the number of people to be served to provide a visual indication of a number of servings selected.

### BACKGROUND

Conventional online catering menus, such as on websites associated with restaurants, may be used for ordering larger quantities of food, such as for events hosting a group of people. For example, a buyer may access a restaurant website online to order food for a catered event for a group of people. When the buyer is ordering the catered food, he or she might pick one entrée item that feeds 10-12 people, several side dish items that feed 8 people each, two more vegetarian entrée items that feed 5-7 people, and so forth. Subsequently, at a checkout page, the buyer may need to ensure that there is a sufficient quantity of food for the number of people expected at the event, so the buyer may have to click back into items in the cart to double check their descriptions, number of servings, or the like. This process may be further complicated if the person desires to obtain items from two or more different merchants.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example system for managing online order item quantities according to some implementations.

FIG. 2 illustrates an example item ordering user interface (UI) for managing online order item quantities according to some implementations.

FIG. 3 is a block diagram illustrating an example framework for determining a number of servings for a multiple-serving item according to some implementations.

FIG. 4 is a flow diagram illustrating an example process for presenting a graphic indicator for selected items and updating the number of servings indicated for an item in a data structure according to some implementations.

FIG. 5 is a flow diagram illustrating an example process for adjusting a number of servings attributed to a multiple-serving item according to some implementations.

FIG. 6 illustrates select components of one or more example service computing devices according to some implementations.

FIG. 7 illustrates select components of an example buyer device according to some implementations.

FIG. 8 illustrates select components of an example merchant device according to some implementations.

### DETAILED DESCRIPTION

The technology herein includes novel arrangements and techniques for an item ordering user interface (UI) including an interactive graphic indicator that indicates how many people are predicted to be served by a plurality of selected menu items. The item ordering UI may communicate with a service computing device of a service provider that maintains an item information data structure used for updating the graphic indicator following each selection made by a buyer. Further, the item ordering UI may track items selected by the buyer from multiple different merchants and may include the items from multiple different merchants in the total of serving quantities presented in the graphic indicator. In addition, the service computing device may use machine learning or other analysis techniques to update how many people are predicted to be served by selected multiple-serving items during subsequent ordering sessions by the buyer or other buyers.

A service computing device may maintain or otherwise access an item information data structure that includes a record for each multiple-serving item offered for catering orders by each merchant of a plurality of different merchants. Thus, each multiple-serving item offered by each merchant may have its own record in the item information data structure. Each of the data structure records may include a “number-of-people-served” field that indicates how many people each multiple-serving item is predicted to feed. In some cases, the merchants may initially provide the information regarding number of people served by each multiple-serving item when providing item information to the service computing device of the service provider. For instance, when a merchant signs up for the service or updates item information for the service, the merchant may provide item information, such as an item description, item images, item pricing, item preparation time, and item spoilage time, and may also provide an estimate of the number of people the merchant believes the multiple-serving item will serve.

When a buyer filling a catering order adds a multiple-serving item to the buyer's cart via the item ordering UI on the buyer device, the buyer device may send a communication indicating the selection to the service computing device. The service computing device may receive the communication and determine the number of people served by the selected multiple-serving item by accessing the item information data structure. Based on serving quantity information obtained from the item information data structure, the service computing device sends UI information to the buyer device to cause the buyer device to update the graphic indicator in the item ordering UI. For example, the UI information may cause the buyer application on the buyer device to add or change a graphic effect in the graphic indicator in the item ordering UI. Thus, the graphic indicator may be updated in the item ordering UI in response to each selection of an item to indicate how many people are going to be served based on the newly selected item and any selected items already in the buyer's virtual cart.

The graphic indicator may further indicate how many people may have not yet been served out of a total number of people indicated by the buyer. For example, when a buyer first accesses the item ordering UI, the buyer may be asked to enter the number of people that the buyer wants to have served by the catering order. The item ordering UI may be presented by a buyer application executing on the buyer device. In some cases, the buyer application may be a dedicated item-ordering application provided by the service provider. In other cases, the buyer application may include a browser that accesses the item ordering UI through a website of the service provider. In some cases, the item ordering UI may be provided only to certain buyers, such as corporate customers, and may be turned off or otherwise not provided to other types of customers. In other cases, however, the item ordering UI may be accessed by any buyer who wishes to place a catering order, such as by selecting a catering ordering option.

Catering orders may differ from individual-item orders placed by buyers who order for their own consumption. For example, catering items included in catering orders are multiple-serving items that are prepared and packaged for serving a plurality of people, such as 8 people, 10 people, 20 people, 40 people, and so forth. Catering orders may typically be placed by a single buyer or buyer employee, such as an office administrator, event planner, or other person who is responsible for ordering enough food to feed a plurality of people.

The item ordering UI herein may include an input entry for the buyer to enter the number of people to be served. Based on the number of people entered into the item ordering UI, the buyer application may generate the graphic indicator and may automatically fill in or otherwise modify the graphic indicator to represent items added to the buyer's cart. For instance, the graphic indicator may include different representations for different item categories, such as main dish (entrée) items, side dish items, appetizer items, and/or dessert items, and may include different graphic effects for the different item categories and for different subcategories of item categories, such as vegetarian items, non-vegetarian items, gluten-free items, kosher items, and so forth.

The top of the graphic indicator may be equal to the total number of people indicated to be served, and the buyer application may add the graphic effects to the graphic indicator as the buyer selects multiple-serving items to add to the buyer's cart. Further, the graphic indicator may indicate both graphically and numerically the number of people served by the items selected so far, and the number of people for whom items still need to be selected. As one example, if the buyer attempts to complete the order without having selected a sufficient number of items for the specified number of people expected at the catered event for one or more of the item categories selected, the item ordering UI may present a warning to the buyer. For example, the item ordering UI may indicate that the buyer still needs to select main dishes for eight more people and side dishes for ten more people.

In some cases, machine learning or other computational analysis techniques may be applied to determine the number of people a selected item feeds, rather than relying entirely on merchant predictions of the number of people served. For instance, the service computing device may maintain a past order data structure that includes detailed information of quantities of items ordered by each buyer and how many people were intended to be served by each order. Further, the service computing device may track follow-up orders to an original catering order to ascertain whether the original amount was insufficient for the specified number of people. For example, the service computing device can determine that the merchant estimate of the number of people served by an order is too high if there is a fast follow-up order placed within a threshold period of time following delivery of the original order. In other words, if there is not enough food included in the original order, the buyer may order more food shortly after the original order is received, and this follow-up order may be associated with the original order for determining how much of a food deficit there may have been in the original order.

Some examples herein include a computational model that observes adaptive buyer behavior over the long term. As one example, because the buyer received too much food in a first order, the buyer may order less food in future orders to feed the same number of people. In addition, after the order has been provided to the buyer, the service computing device may send a communication to the buyer to determine whether the quantity of food provided was accurate and matched the quantity estimated. Additionally, or alternatively, the buyer may provide feedback through the buyer application or other electronic communication techniques following the catered event to indicate whether there was a surplus of food or a deficit of food.

In addition, as another example, the service computing device may receive information from merchant restaurants that may indicate how many of individual servings of the respective items people order at the merchant restaurant. A computational model may be used to determine how much food is included in each individual serving order, and may apply this information for determining the number of people able to be fed by a multiple-serving order of the same item based on the buyer behavior at the restaurant.

Thus, some implementations herein may include receiving an indication of a quantity of people to be served and menu item selections for an order, and sending UI information to the buyer device to cause the buyer device to present a graphic indicator to indicate whether a sufficient number of servings have been selected for respective item categories. In addition, some examples include constructing a past order data structure and applying machine learning to the data structure for determining the number of people actually served. The system may adjust the number of servings indicated in the item information data structure so that the number of servings will be more accurate for future orders.

In the examples herein, an order may include a request submitted by a buyer (e.g., a customer) using a buyer device for the acquisition of an item, such as a food item, from a merchant. The order information may be received by the service computing device and may be sent by the service computing device to the merchant device. In the case that delivery is selected, the order information may also be sent to a selected a courier device of a courier who will deliver the selected items. A merchant may include a restaurant or any other business or other entity engaged in the offering of items for delivery to buyers. Actions attributed to a merchant herein may include actions performed by employees or other agents of the merchant and, thus, no distinction is made herein between merchants and their employees unless specifically discussed. In addition, a buyer may include any entity that purchases an item prepared by a merchant. Buyers may include customers, potential customers, and employees of customers. The service provider may provide payment to the merchant for the ordered items, provide payment to the courier for delivering the items, and may receive payments from the buyers for the ordered items.

For discussion purposes, some example implementations describe a technological architecture including a distributed system of devices and an item ordering UI for catering orders. However, implementations herein are not limited to the particular examples provided, and may be extended to other service environments, other system architectures, other types of items, other types of orders, and so forth, as will be apparent to those of skill in the art in light of the disclosure herein.

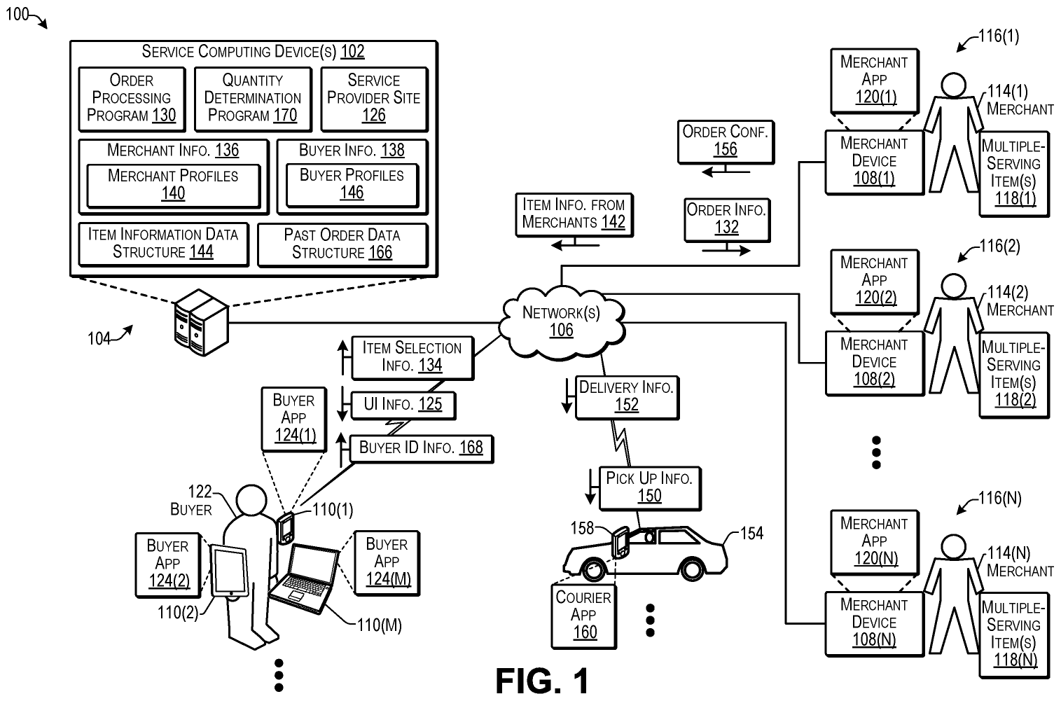

FIG. 1 illustrates an example system 100 for managing online order item quantities according to some implementations. The system 100 includes one or more service computing devices 102 associated with a service provider 104 to provide a service for ordering catering items from merchants. The service computing device(s) 102 may be able to communicate over one or more networks 106 with one or more merchant devices 108 and one or more buyer devices 110. In some examples, the service provider 104 may be a business, enterprise, or other entity that offers, sells, supplies or otherwise enables the service described herein.

The one or more networks 106 can include any appropriate network, including a wide area network, such as the Internet; a local area network, such as an intranet; a wireless network, such as a cellular network, a local wireless network, such as Wi-Fi and/or short-range wireless communications, such as BLUETOOTH® and BLUETOOTH® low energy; a wired network, including fiber optics and Ethernet; or any other such network, or any combination thereof. Accordingly, the one or more networks 106 may include both wired and/or wireless communication technologies. Components used for such communications can depend at least in part upon the type of network, the environment selected, or both. Protocols for communicating over such networks are well known and will not be discussed herein in detail. Accordingly, the service computing device 102, the merchant devices 108, the buyer devices 110, and/or other devices described herein are able to communicate over the one or more networks 106 using wired or wireless connections, and combinations thereof.

Each merchant device 108(1), 108(2), . . . , 108(N) may be associated with a respective merchant 114(1), 114(2), . . . , 114(N), such as at a particular geographic location that serves as a point of sale (POS) location 116(1), 116(2), . . . , 116(N) for the respective merchant 114(1), 114(2), . . . , 114(N). In some examples, each merchant 114(1), 114(2), . . . , 114(N) may offer various types of multiple-serving items 118(1), 118(2), . . . , 118(N), respectively, as well as other types of menu items. For instance, the merchants may be restaurants or other entities that offer multiple-serving items 118, such as catering items and bulk serving items for feeding a plurality of people.

The merchant devices 108(1), 108(2), . . . , 108(N) may be computing devices that each include an instance of a merchant application 120(1), 120(2), . . . , 120(N), respectively, that executes on each respective merchant device 108(1), 108(2), . . . , 108(N). For instance, in some cases, the merchant application may be provided by the service provider 104 to enable the merchants to receive online orders from buyers and also process orders at a point of sale for buyers in person.

In some examples, the merchant application 120 and associated hardware (e.g., card reader, barcode scanner, etc., as discussed below) may specifically configure the merchant device 108 to provide POS functionality to the merchant device 108 to enable the merchant 114 to accept payments at the POS location 116. For example, the merchant 114 may use the merchant device 108 to accept payments at the POS location 116 from one or more buyers 122 using a variety of payment instruments, such as payment cards, cash, checks, mobile wallets, etc., in addition to the electronic payments discussed herein. In other examples, the merchant device 108 may be a computing device that is separate from a POS device at the POS location 116.

Each buyer 122 may be associated with one or more buyer devices 110(1), 110(2), . . . , 110(M), that each may execute a respective instance of a buyer application 124(1), 124(2), . . . , 124(M). For example, some buyers 122 may carry buyer devices 110, such as smart phones, tablet computers, wearable computing devices, or the like, as further enumerated elsewhere herein, and some of these buyer devices 110 may have installed thereon the buyer application 124. In other examples, the buyer devices 110 may be semi-stationary or stationary computing devices such as laptop computers, desktop computers, or the like, that have the buyer application 124 installed thereon.

The buyer application 124 may include electronic payment capability, which enables the buyer 122 to make a payment to the merchant 114 using the buyer application 124, rather than paying in person with a physical payment card, cash, or other payment instrument. The buyer application 124 may further enable the buyer 122 to order one or more multiple-serving items 118 in addition to paying for the multiple-serving item(s) 118, such as by enabling the buyer to select the multiple-serving item 118 for being added to a virtual shopping cart as an indication of an intent to purchase the multiple-serving item 118.

In some cases, the buyer application 124 may be a dedicated item-ordering application capable of generating an item ordering UI (not shown in FIG. 1) based on UI information 125 received from the service computing device(s) 102. For instance, the service provider 104 may provide the buyer application 124 for download to buyer devices 110. In other cases, the buyer application 124 may include a browser that receives the UI information 125 from a service provider site 126 provided by one or more of the service computing devices 102. For instance, the buyer application 124 may generate or receive the item ordering UI and may receive the UI information 125 from the service provider site 126 of the service provider 104.

In some cases, the one or more service computing devices 102 may include one or more web servers, or the like, and the service provider site 126 may include or provide one or more of websites, ecommerce sites, online menus, webviews, or the like, as the service provider site 126, which may be accessed by the buyer 122 using the buyer device 110 to enable the buyer 122 to view the multiple-serving items 118 offered by each merchant 114. Thus, the buyer 122 may use the buyer application 124 to select a multiple-serving item 118 by virtually placing the multiple-serving item 118 into a virtual cart. For example, virtually placing the multiple-serving item 118 into a virtual cart may include receiving a buyer input via the item ordering UI presented by the buyer application 124 to indicate that the buyer 122 has selected a particular multiple-serving item 118 for purchase.

The service computing device(s) 102 may receive an indication of this buyer input, and in response may send UI information 125 to update the item ordering UI on the buyer device 110, such as to indicate a quantity of an item category that corresponds to the selection. Further, as discussed additionally below, when an order has been placed by the buyer 122, the service provider site 126 and/or an order processing program 130 executing on the service computing device(s) 102 may communicate order information to the corresponding merchant application 120 on the respective merchant device 108 to provide information related to the order received from the buyer application 124.

The service computing device(s) 102 may execute the order processing program 130 to receive item selection information 134 through communication with the buyer application 124, either directly or via the service provider site 126. For instance, the item selection information 134 may include an indication of a selection of one or more multiple-serving items 118 to be added to the buyer's virtual cart. In response, the order processing program may send the UI information 125, as discussed above, either directly or via the service provider site 126, to cause the buyer application 124 to update the graphic indicator in the item ordering UI based on the selected multiple-serving item(s) 118.

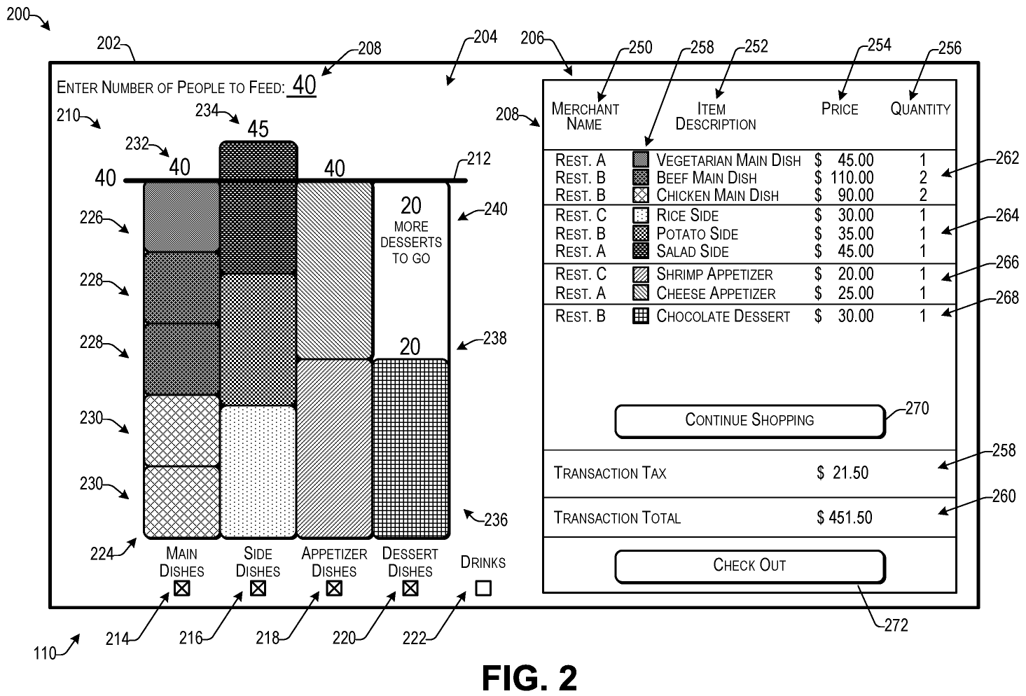

As mentioned above, the item ordering UI may include an input entry for the buyer 122 to enter the number of people to be served. Based on the number of people entered, the buyer application 124 may generate a graphic indicator (not shown in FIG. 1). As the buyer selects one or more multiple-serving items 118 to add to the buyer's cart, the item selection information 134 is sent to the service computing device(s) 102. The order processing program 130 may send UI information 125 to the buyer device 110 based on the received item selection information 134. In response, the buyer application 124 may update the graphic indicator based on the UI information 125 received from the order processing program 130 each time the buyer adds a multiple-serving item 118 to the virtual cart to represent graphically the one or more multiple-serving items 118 added to the buyer's cart. For instance, the graphic indicator may represent different item categories, such as main dish (entrée) items, side dish items, appetizer items, dessert items, and so forth. Thus, the graphic indicator may track the progress of the buyer 122 in fulfilling the goal of selecting a sufficient amount of food to feed a specified number of people. Additional details of the item ordering UI and updating the graphic indicator are discussed below, e.g., with respect to FIG. 2.

In addition, based on the item selection information 134, the order processing program 130 may receive or determine transaction information for an order, such as by generating a description of one or more multiple-serving items 118 selected, an amount to be charged for each multiple-serving item 118, an amount to charge for tax, an amount of gratuity to be added, an overall amount to charge for the order, and so forth. Further, when the order is placed by the buyer 122, the order processing program 130 may receive payment for the order through one or more payment instruments associated with the buyer 122 and/or the buyer application 124, thus enabling electronic payments to be made through the buyer application 124 for the selected items 118.

In the case that the buyer 122 is using the buyer application 124 to pay electronically, any of several techniques may be employed for making electronic payments. As one example, the buyer 122 may establish an account with the service provider 104 through the buyer application 124. For instance, the buyer 122 may link a credit card, a buyer financial account, or other payment instrument to the buyer application 124. Subsequently, the buyer 122 may interact with the buyer application 124 to select one or more multiple-serving items 118 from one or more merchants 114 who participate in the service offered by the service provider 104. Further, the buyer 122 may use the buyer application 124 to pay for one or more selected multiple-serving items 118. When the buyer 122 authorizes a payment for an order through the buyer application 124, the service computing device(s) 102 may charge a linked buyer account associated with the buyer application 124 and may credit a merchant account of the corresponding merchant 114. As an alternative, when a buyer 122 uses the buyer application 124 to order a multiple-serving item 118 via the service provider site 126, the buyer 122 may submit payment instrument information via the service provider site 126, with or without establishing a buyer account with the service provider 104.

The order processing program 130 may use and/or maintain merchant information 136 and buyer information 138. To sell multiple-serving items 118 through the service provided by the service provider 104, each merchant 114 typically creates a merchant profile 140 with the service provider 104 by providing information describing the merchant including, for example, a merchant name, contact information, e.g., telephone numbers, the merchant's street address, and one or more financial accounts to which funds collected from buyers 122 will be deposited. Further, the service provider 104 may also associate with the merchant profile 136 additional information about the merchant, such as a record of each order processed for the merchant by the service computing device(s) 102.

In addition, the merchant profile 136 may include item information 142 received from the merchants 114. The item information 142 from the merchants may include a menu or other listing of items offered by the merchant, which may include both multiple-serving items 118 and single-serving items (not shown in FIG. 1). The item information 142 may further include prices and descriptions associated with each item offered by the merchant, images of the items, and other item information as described elsewhere herein. The order processing program 130 may organize the item information received from the merchants 114 into an item information data structure 144 that may include item category (e.g., main dish, side dish, appetizer, dessert, etc.) of each item, item descriptions or other identifying information, item pricing, and a number of people served by each multiple-serving item 118. The item information data structure 144 may further include other information that may be useful to a buyer 122 or the service provider 104, such as spoilage time, preparation time, nutritional information, ingredients, and so forth.

Further, in some examples, before conducting an electronic transaction for placing an order, the buyer 122 may create a buyer profile 146 with the service provider 104. The buyer 122 may create the buyer profile 146, for example, by interacting with the buyer application 124. When enabling electronic payments with the service provider 104, the buyer 122 may provide data describing a financial account of the buyer 122, e.g., a credit card number, expiration date, and a billing address. Further, the buyer profile 146 may include demographic information about the buyer 122, a record of transactions conducted by the buyer 122, types of food preferred by the buyer 122, a default delivery location, and so forth.

In some examples, a large number of the buyers 122 may use the system 100 for placing orders for multiple-serving items 118. For instance, individual buyers 122 may place orders for one or more of the multiple-serving items 118 for delivery to a delivery location specified by the buyer 122. The service computing device(s) 102 may receive each buyer's order and, based on the buyer's order, the service computing device(s) 102 may send the order information 132 to the respective merchant(s) 114.

Furthermore, the service computing device(s) 102 may send pickup information 150 and delivery information 152 to a selected courier 154, who may pick up one or more of the selected multiple-serving items 118 and deliver the picked up items 118 to a delivery location specified by the respective buyer 122. For example, each buyer order may include or may otherwise be associated with a respective delivery location. Alternatively, in other examples, a buyer 122 may elect to pick up the ordered multiple-serving item(s) 118 from the one or more respective merchants 114. For example, the item ordering UI may present the buyer with a virtual control to elect pickup rather than delivery of one or more selected multiple-serving items 118.

Each merchant device 108 may be a computing device, such as a desktop, laptop, tablet, smart phone, or the like, and may include a respective instance of the merchant application 120 that executes on the respective merchant device 108. For example, the merchant application 120 may specifically configure the respective merchant device 108 to communicate with the service computing device(s) 102, such as for receiving the order information 132 and for sending merchant order confirmation information 156 in response to receiving the order information 132. In some examples, the merchant application 120 and the service computing device 102 may communicate with each other via one or more application programming interfaces (APIs).

In addition, the courier(s) 154 may be associated with respective courier devices 158, which may execute respective instances of a courier application 160. For example, couriers 154 may use the courier devices 158, such as smart phones, tablet computers, wearable computing devices, laptops, or the like, and these courier devices 158 may each have installed thereon an instance of the courier application 160 to specifically configure the computing device as the courier device 158. The courier application 160 may configure the courier device 158 to receive the pickup information 150 and/or the delivery location information 152 from the service computing device(s) 102, such as to provide the courier(s) 154 with information for picking up multiple-serving items 118 from merchants 114 and delivering the multiple-serving items 118 to buyers 122. The courier application 160 may further configure the courier device(s) 158 to send location information obtained from one or more location sensors associated with the respective courier device 158, such as a GPS receiver (not shown in FIG. 1). In some examples, the service provider 104 may charge a delivery fee to the buyer 122 and may pay a payment to the courier 154 based on the delivery fee, a cost of the order, or the like, following delivery of the order to the delivery location specified by the buyer 122.

As the order processing program 130 processes transactions for completing orders, the order processing program 130 may store information related to the orders in a past order data structure 166. The past order data structure 166 may include a large amount of information about each order, such as items ordered; quantity of people to be served as specified by the buyer; quantity of people that the ordered items are supposed to serve as specified by the merchant; particular times at which the orders were placed, particular days of the week, particular dates, and so forth. Further, the past order data structure 166 may include feedback from the buyer or other people who attended the event for which the items 118 were ordered. In some cases, the feedback may include whether there was a sufficient quantity of food, food left over, as well as whether the quality and freshness of the food was sufficient, the service was satisfactory, and the like.

The merchant profiles 140, buyer profiles 146, item information data structure 144 and/or past order data structure 166 may be created and maintained using any suitable types of data structures, and using any suitable data storage or database techniques. In some examples, the profiles 140 and 146, and the data structures 144 and 166 may be maintained in a relational database. For example, pieces of information for individual buyer profiles 146 and merchant profiles 140 may be stored distinctly from one another, but are related to or otherwise associated with particular profiles in the relational database. For instance, a particular buyer profile 146 may be obtained by generating a view of a portion the data related in the database to the particular buyer profile 146, or by otherwise extracting the data from the database. Alternatively, of course, other types of storage techniques and data structures may be used for generating and maintaining the profiles 140, 146 and data structures 144, 166.

In some examples, in response to an item selection, the item selection information 134 and buyer identifying information 168 may be sent from the buyer device 110 to the order processing program 130 at the service computing device(s) 102. For instance, when the buyer 122 begins browsing merchants and/or selects a virtual control to add a multiple-serving item 118(1) to the virtual cart (not shown in FIG. 1), the buyer 122 may be prompted to enter a user ID and a password associated with the buyer profile 146 of the particular buyer 122, or provide other buyer identifying information 168 that identifies the particular buyer 122 associated with a particular buyer profile 146.

As another alternative, if the buyer 122 has already signed in to the payment service, the order processing program 130 may be able to associate the buyer selection with the buyer profile 146 based on a cookie maintained on the buyer device 110, such as in the case that the buyer application 124 is a browser or includes browser-like functionality. For example, a cookie may include a small data file stored on the buyer device 110 by the buyer's browser or other buyer application 124. The cookie can include buyer identifying information about the buyer, information about a merchant from which a selection was made, information about the service provider, information about the virtual cart, or the like. Further, if an identifying cookie is not present on the buyer device 110, the buyer 122 may be presented with a login UI, or the like, to enable the buyer 122 to provide buyer identifying information 168, which may be used to generate a cookie for placement on the buyer device 110.

As another alternative, in the case that the buyer application 124 is a mobile ordering and payment application or other dedicated ordering application, the buyer application 124 may provide the buyer identifying information 168 to at least one of the service provider site 126 or the order processing program 130. When the buyer 122 has finished adding desired items 118 to the virtual cart 140, the buyer 122 may select a virtual control to send a checkout request to the order processing program 130 to notify the order processing program 130 that the buyer 122 is ready to finalize the order and pay for the items included in the virtual cart 140.

The service computing device(s) 102 may further include a quantity determination program 170 that may be executed by the service computing device(s) 102 to determine whether the quantity of people served by a multiple-service item 118 is accurate or should be adjusted. The quantity determination program 170 may use any of a variety of techniques for checking item quantities and adjusting the indicated number of people served by an item in the item information data structure 144.

As one example, the quantity determination program 170 may apply machine learning, such as computational modeling, and/or other analysis techniques to determine the number of people a selected multiple-serving item 118 feeds, rather than relying entirely on merchant predictions of the number of people served. For instance, the quantity determination program 170 may access the past order data structure 166, which includes detailed information of quantities of items ordered by each buyer and how many people were intended to be served by each order. Further, the quantity determination program 170 may track follow-up orders that are made by a buyer following an original multiple-serving item order to ascertain whether the original amount was insufficient for the specified number of people. For example, the quantity determination program 170 may determine that the merchant estimate of number of people served by an order is too high based on determining that a fast follow-up order was placed by the buyer within a threshold time following delivery of the original order. For instance, if the original order did not include enough food, the buyer may order more food immediately, and the follow up order may be associated with the original order for determining how much of a food deficit there may have been in the original order.

In addition, the quantity determination program 170 may apply machine learning that determines adaptive buyer behavior that may take place over the long term. As one example, if a buyer receives too much food, the buyer may order less food in the future from the same merchants to feed the same amount of people. Additionally, or alternatively, after the order has been delivered or otherwise provided to the buyer, the quantity determination program 170 may send a communication to the buyer device 110 to determine whether the quantity of food provided matched the quantity of servings estimated in the item information data structure 166. Additionally, or alternatively, the buyer may provide feedback through the buyer application 124 or other through electronic communication techniques following the catered event to indicate whether there was a food surplus or food deficit.

As another example, the quantity determination program 170 may receive order information from the merchants 114 that may indicate how many of individual servings of the respective items people order at the merchant restaurant to determine how much food is included in each individual serving order. The quantity determination program 170 may then apply this information for determining the number of people able to be fed by a multiple-serving order of the same item.

FIG. 2 illustrates an example item ordering UI 200 for managing online order item quantities according to some implementations. The item ordering UI 200 may be presented on a display 202 of the buyer device 110. The item ordering UI 200 is illustrated for use with a touch input device and, accordingly, the display 202 may include a touch sensor (not shown in FIG. 2). However, other types of interfaces may be used with the examples herein and, accordingly, the examples herein are not limited to any particular type of interfaces or user input devices.

In the illustrated example of FIG. 2, the buyer application presents the item ordering UI 200, such as in response to the buyer navigating the buyer application to the service provider site or otherwise accessing the buyer application. For instance, when the buyer application is navigated to the service provider site, the buyer application may receive site information (e.g., Hypertext Mark Language (HTML) formatted information, JAVASCRIPT® code, and so forth) as UI information received from the service provider site to enable the buyer application to present the item ordering UI 200 on the display 202. The user may browse through merchants and items offered by merchants to locate one or more items that the buyer desires to purchase. The presented information may include item representations, images, descriptions, prices, and so forth, of a plurality of multiple-serving items offered by the merchants, such as in the form of selectable icons, links, or the like. The buyer may select one or more items for purchase, which may result in the selected item being added to a virtual cart. The buyer subsequently may be presented with or may otherwise access the item ordering interface 200.

In this example, the item ordering UI 200 includes a graphic indicator UI 204 and a virtual cart UI 206. As mentioned above, the item ordering UI 200 may include an input entry 208 for the buyer to enter the number of people to be served by the current order. Based on the number of people to be served entered at 208, the buyer application may generate a graphic indicator 210 as part of the graphic indicator UI 204. In some examples, such as in the case that the buyer application is a browser, the number entered at 208 is sent to the service provider site and the service provider site sends back UI information to cause the graphic indicator 210 to be displayed and/or updated. In other cases, the buyer application may generate the initial graphic indicator locally based on the number entered at 208 and the item categories selected by the buyer, as discussed additionally below.

A dimension of the graphic indicator 210 may be set equal to the total number of people indicated to be served at 208. In this example, the graphic indicator 210 is arranged vertically so a top 212 of the graphic indicator 210 is equated to 40 servings. In other examples, the graphic indicator 210 may be configured differently, such as horizontally, in which case a side of the graphic indicator 210 may be equated to the selected number of servings at 208.

In addition, the graphic indicator 210 may be configurable for different categories of multiple-serving items. Selectable item categories in this example include main dishes 214, side dishes 216, appetizer dishes 218, dessert dishes 220, and drinks 222. In this example, suppose that the buyer has selected categories 214-220 by selecting boxes adjacent each category, but has not selected the drinks category 222, as indicated by the unselected box adjacent the drinks category 222. As a result, the item ordering UI 200 generates respective graphic indicator portions for the selected categories 214-220, but does not generate a graphic indicator for the unselected category 222. Furthermore, while example item categories are illustrated in this example, in other examples, more, fewer, or different item categories may be included.

As mentioned above, the buyer application may add graphic effects to the graphic indicator 210 as the buyer selects items to add to the buyer's cart. The graphic effects may include color coding or use of particular graphic patterns or other graphic effects to convey various types of information. For example, meat-based dishes may be presented with a first color, graphical pattern, or other graphic effect, vegetarian dishes may be presented with a second color, graphical pattern, or other graphic effect, etc. Furthermore, items may be tagged or otherwise marked for various additional attributes, e.g., vegan, gluten-free, kosher, etc.

Additionally, the graphic indicator 210 may indicate both graphically and numerically the number of people served by the items selected so far, and the number of people for whom items still need to be selected. For instance, suppose the buyer has selected a vegetarian main dish that serves eight people, two orders of a beef main dish that serves eight people, and two orders of a chicken main dish that serves eight people. In this example, the vegetarian main dish is represented in the main dish graphic indicator portion 224 using a first graphic effect 226, such as a first color, pattern, crosshatching, or the like. The beef main dish is represented in the main dish graphic indicator portion 224 with a second graphic effect 228, and the chicken main dish is represented in the main dish graphic indicator portion 224 with a third graphic effect 230. In addition, because the selected items total 40 servings, the number 40 is displayed at the top of the graphic indicator portion 224, as indicated at 232.

Further, in some cases, the number of servings selected by the buyer may exceed the number of servings specified at 208. In this case, the corresponding graphic indicator portion may extend beyond the top of the graphic indicator, as indicated at 234. For instance, at the side dish graphic indicator portion 234, suppose that the buyer selected three different side dishes that serve 15 people each. Thus, a total of 45 servings are displayed in the side dish graphic indicator portion 234.

In addition, in this example, suppose that the buyer has not yet selected enough dessert dishes. Accordingly, a graphic indicator portion 236 for the dessert dishes may include a first graphic effect 238 indicating that a dessert item with 20 servings has been selected. The dessert graphic indicator portion 236 may further include an indication that 20 more dessert servings are still needed, as indicated at 240.

In some examples, if the buyer attempts to complete the order and check out without having selected a sufficient number of items for the number of servings specified at 208 for one or more of the item categories selected, the item ordering UI 200 may present a warning to the buyer. For example, the item ordering UI 200 may present a warning that indicates that the buyer may still want to select dessert dishes for 20 more people.

As the buyer selects one or more items, such as multiple-serving items, to add to the buyer's cart, the item selection information 134 is sent to the service computing device(s) 102. The order processing program may access the item information data structure to determine the number of servings for the selected item, and may send this information back to the buyer device with UI information. In response, the buyer application may update the graphic indicator 210 based on the UI information received from the order processing program each time the buyer adds an item to the virtual cart. Thus, the graphic indicator 210 is updated in real time to represent one or more items added to the buyer's cart as the buyer uses the buyer application to make selections of items. Accordingly, the graphic indicator 210 may track the progress of the buyer in fulfilling the goal of selecting a sufficient amount of food to feed the number of people specified at 208.

In the illustrated example, the buyer application 124 presents the cart UI 206 concurrently with the graphic indicator UI 204 discussed above. For instance, the cart UI 206 may provide a representation of the contents of the buyer's virtual shopping cart, and may include, for each item in the cart, the merchant name 250 of the merchant from whom the item was selected (i.e., Restaurant A, Restaurant B, or Restaurant C in this example), an item description 252, a price 254 for each item, and a quantity 256 of orders of each selected item. In addition, the cart UI 206 may indicate the taxes 258 to be collected and the total amount 260 of the transaction.

Furthermore, in other examples, the cart UI 206 may include a delivery fee to be added for delivery of the selected items, an added gratuity, or any other incidental charges associated with the order. The buyer may interact with the cart UI 206 to review the cart information, edit items in the cart, add or edit a gratuity, and authorize payment of the transaction amount. In some instances, the buyer application may present an additional user interface that enables selection of delivery or pick up, entry of a gratuity amount and entry of a signature or other buyer payment authorization. Further, the buyer may receive a receipt or other order confirmation information, such as through email, in-application communication, or other types of electronic communications.

In this example, the cart UI 206 further includes graphic effect keys 258 located adjacent to the item description 256 for each selected item. Each graphic effect key 258 includes a graphic effect that matches the graphic effect used for the respective item in the graphic indicator 210. Thus, the buyer is able to use the graphic effect keys 258 to visually relate the respective items in the cart to the corresponding graphic effects in the graphic indicator 210.

In addition, the listed items may be grouped together according to the same item categories as in the graphic indicator 210. Thus, group 262 may correspond to main dishes, group 264 may correspond to side dishes, group 266 may correspond to appetizers, and group 268 may correspond to desserts.

Additionally, in the illustrated example, the cart UI 206 includes a first virtual control 270 that the buyer may select to continue shopping. For example, the buyer may select the virtual control 270 to be redirected to a UI for browsing merchants and items offered by the merchants. Further, the cart UI 206 includes a second virtual control 272 that the buyer may select to check out if the buyer wishes to complete the order and proceed to a payment and confirmation UI.

In addition, based on the item selection information, the order processing program 130 may receive or may determine transaction information for the order, such as by determining UI information for generating the cart UI 206 including determining the prices of the items selected, the amount to charge for tax, the total amount to charge for the order, and so forth. Further, when the order is placed by the buyer, the order processing program 130 may receive payment for the order through one or more payment instruments associated with the buyer and/or the buyer application, such as by enabling electronic payments to be made through the buyer application for the selected items.

In response to receiving a payment authorization or other payment instruction from the buyer device, the order processing program may charge the payment amount to an account associated with the buyer and/or the buyer application, such as by charging a credit card previously linked to the buyer's electronic payment account. Furthermore, the order processing program 130 may credit an account of each of the merchants by an amount based on the payment provided by the buyer through the buyer application. As an example, the order processing program may credit the account of a respective merchant for the amount of the items purchased, inclusive of any gratuity added by the buyer for the merchant, and minus any delivery fees, taxes, and/or service fees.

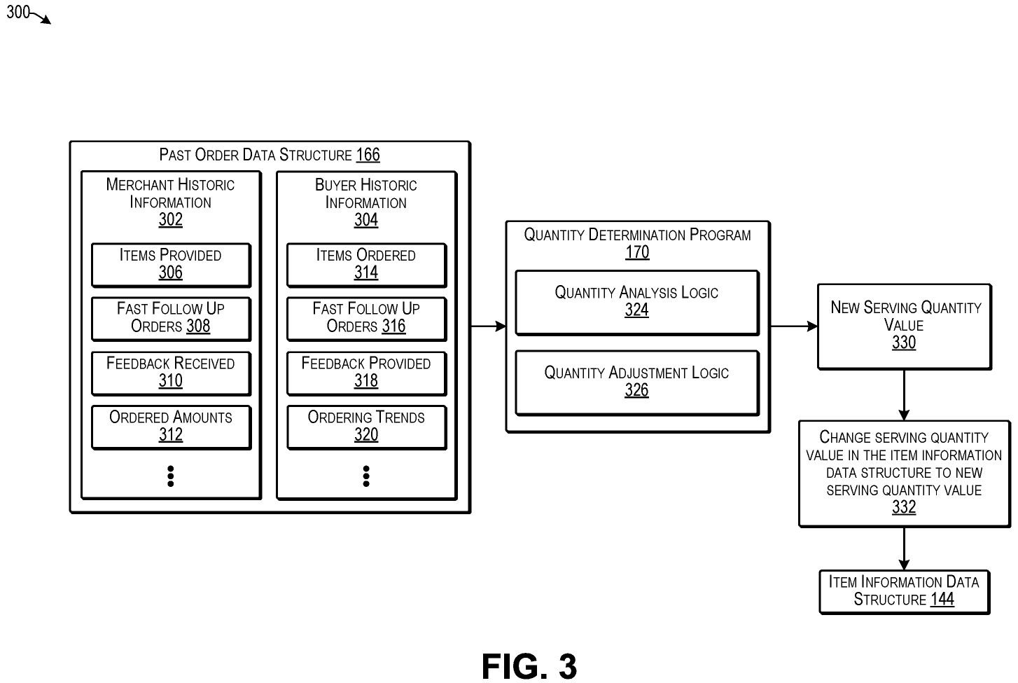

FIG. 3 is a block diagram illustrating an example framework 300 for determining the serving quantity value (number of people served) for a multiple-serving item according to some implementations. As mentioned above, in some examples, the service computing device may receive, from a plurality of merchant devices associated with a plurality of respective merchants, item information indicating multiple-serving items offered by the respective merchants, a number of servings provided by each multiple-serving item, and a category of the multiple-serving item as a main dish (entrée), side dish, appetizer, or dessert. The service computing device may construct an item information data structure 144 that includes the number of servings provided by the multiple-serving item offered by each respective merchant and categorization of the menu item as main dish, side dish, appetizer, or dessert. Thus, the number of servings in the item information data structure 144 is initially dependent on the merchant's estimate. To improve the accuracy of this information, implementations herein may execute the quantity determination program 170 that performs processing to determine and improve the accuracy of the indicated number of people served in the item information data structure 144.

Initially, the service computing device may receive, from a buyer device, via the item ordering UI presented by the buyer application executing on the buyer device, an indication of a quantity of people to be served for an order being placed by the buyer. For example, the buyer may access the service through a dedicated buyer application or through a buyer application that includes a browser that accesses a service provider website. The service computing device may receive, from the buyer application, an indication of a selection of a plurality of different multiple-serving items. The service computing device may determine, from the data structure, the serving quantity value for each selected multiple-serving item and the category for each selected multiple-serving item. In addition, the service computing device may send, to the buyer device, UI information to cause the buyer application to present the item ordering UI including the graphic indicator with a graphical indication of each selected menu item by category of the selected menu item and the number of servings of the selected menu item relative to the quantity of people to be served. Thus, the serving quantity value from the item information data structure is used to provide a visual indication of whether a sufficient number of servings have been selected for respective categories of multiple-serving items. The service computing device may receive, from the buyer application, an order for at least the selected menu items.

Furthermore, subsequently, the service computing device may receive, from the buyer application, at least one form of feedback regarding a number of people actually served by at least one of the selected menu items. In some examples, the feedback may be provided directly by the buyers. Additionally, or alternatively, the quantity determination program 170 may perform analysis of past order information included in the past order data structure 166 for a plurality of orders, such as a large number of orders, as discussed additionally below, to determine whether the quantity of people served by the respective multiple-serving items is less than or more than the serving quantity value provided by the respective merchant. In response, the quantity determination program 170 may adjust, in the item information data structure 144, the serving quantity value specified for a selected multiple-serving item based on the feedback.

As an example, the quantity determination program 170 may access the past order data structure 166 including merchant historic information 302 and buyer historic information 304. The merchant historic information 302 includes historic order information related to the merchants, e.g., various types of information related to the merchants that participate in the service of the service provider 104. For instance, the merchant historic information 302 may include items 306 provided by each merchant at particular times on particular days of the week, particular dates, and the like. Further, the merchant historic information 302 may include follow-up orders 308 that were made by a buyer within a threshold time of the provision an earlier order, such as within a half hour, hour, etc., of delivery of the earlier order to the buyer or pick up of the earlier order by the buyer. The merchant historic information may further include feedback 310 received from buyers for items provided by particular merchants. In addition, the merchant historic information may include ordered amounts 312, e.g., the amount of an item typically ordered as a single serving at the merchant's restaurant or the like.

Additionally, the buyer historic information 304 includes historic order information related to the buyers. Examples of buyer historic information 304 may include items ordered 314, e.g., a time of day, day of the week, and date on which each order was placed, item ordered, amount paid, and so forth. The buyer historic information 304 may further include follow-up orders 316 made by the buyer, e.g., orders made by the buyer within a threshold time of when a first order was delivered, picked up, or otherwise received by the buyer. In addition, the buyer historic information 304 may include feedback 318 provided by the buyers, which may include an indication of whether there was too much food or too little food. Furthermore, the buyer historic information 304 may include ordering trends 320, e.g., the buyer is ordering less of the same item for the same number of people than the buyer ordered during one or more previous orders. Furthermore, the merchant historic information 302 and the buyer historic information 304 may include additional types of information, with the foregoing being merely several examples of the types of information that may be used by the quantity determination program 170. Accordingly, while several types of information that may be used by the quantity determination program 170 are illustrated in this example, in other examples, other or additional types of information may be used by the quantity determination program 170, as discussed herein and/or as will be apparent to those of skill in the art having the benefit of the disclosure herein.

In some examples, the quantity determination program 170 may employ quantity analysis logic 324 to determine one or more indications as to whether a serving quantity value for a particular multiple-serving item is too high, too low, or accurate. In some cases, the quantity analysis logic 324 may include one or more computational models and may perform analysis on the merchant historic information 302 and/or the buyer historic information 304. For example, the quantity determination program 170 may employ the quantity analysis logic 324 for determining that a buyer likely received too much food or not enough food in an order for a multiple-serving item.

Additionally, the quantity determination program 170 may employ quantity adjustment logic 326 to determine a new serving quantity value 330 for the selected item. The quantity analysis logic 324 and/or the quantity adjustment logic 326 may each include one or more algorithms, one or more computational models, and/or a plurality of decision-making rules, or the like. Examples of such computational models include predictive models, decision trees, random forest, classifiers, regression models, such as linear regression models, support vector machines and stochastic models, such as Markov models and hidden Markov models, artificial neural networks, such as recurrent neural networks, a set of decision rules, and so forth.

In some examples, the quantity analysis logic 324 may be configured to determine the number of people a selected item serves rather than relying solely on merchant predictions of the number of people served. For instance, the quantity analysis logic 324 may access the merchant historic information 302 and the buyer historic information 304, which includes information on quantities of items ordered by each buyer and how many people were intended to be served by each order. Further, the quantity analysis logic 324 may track follow-up orders to an original catering order to ascertain whether the original amount was insufficient for the specified number of people. For example, the quantity analysis logic 324 can determine that the merchant estimate of the number of people served by an item is too high if there is a follow-up order placed within a threshold time following buyer receipt of the original order. For instance, when not enough food is included in the original order, the buyer may order more food immediately, and this follow-up order may be associated with the original order for determining how much of a food deficit there may have been in the original order.

In addition, in some examples, the quantity analysis logic 324 may include a computational model that recognizes adaptive buyer behavior over the long term. For instance, if a buyer receives too much food, the buyer may begin to order less food in the future to feed the same amount of people. Based on the amount of the reduction, the quantity adjustment logic 326 may determine how much to change the serving quantity value for determining a new serving quantity value 330.

In addition, after the orders have been provided to the respective buyers, the quantity determination program 170 may send communications to the buyers to determine whether the quantity of food provided matched the quantity estimated. Based on the response received from the buyers, the quantity analysis logic 324 may determine which of the multiple-serving items ordered by the buyers included too much or too little food, and the quantity adjustment logic 326 may determine a new quantity served value 330 based on the size of the surplus or deficit determined by the quantity analysis logic 324. Additionally, or alternatively, the buyers may provide feedback through the buyer application or other electronic communication techniques following the catered event to indicate if there was food left over or not enough food, and the feedback may be automatically parsed and analyzed by the quantity analysis logic 324 for determining whether there was a food surplus or deficit.

In addition, the quantity analysis logic 324 may receive information from merchant restaurants that may indicate how many of individual servings of the respective items people order at the merchant restaurant to determine how much food is included in each individual serving order. The quantity analysis logic 324 may apply this information for determining the number of people able to be fed by a multiple-serving order of the same item from the same merchant.

The quantity adjustment logic 326 may take into consideration a plurality of factors when determining new serving quantity value 330 for a selected item. For example, when determining the new serving quantity value 330, the quantity adjustment logic 326 may consider the frequency of a surplus determination or a deficit determination by the quantity analysis logic 324 for the same item from the same merchant. For instance, in the case that sometimes there is a surplus and a similar number of times there is a deficit, the quantity adjustment logic 326 might not make any change to the current serving quantity value for the particular item. On the other hand, if the quantity analysis logic 324 determines relatively consistently that there is a surplus or a deficit, then the quantity adjustment logic 326 may determine the new serving quantity value 330 based on an average of the deficit or surplus determination, or through various other techniques, such as clustering or the like.

After the quantity adjustment logic 326 determines a new serving quantity value 330, then, as indicated at 332, the quantity adjustment logic 326 may change the serving quantity value for the corresponding item in the item information data structure 144. The quantity determination program 170 may continually monitor the serving quantity values for some or all of the items offered by the merchants to ensure that the number of people served estimations remain accurate.

Additionally, while machine learning computational models have been described as one example of a technique for determining whether a serving quantity value is correct and/or how much to adjust the serving quantity value, numerous other techniques, algorithms, decision-making logic, and the like, may additionally, or alternatively, be used. Accordingly, implementations herein are not limited to use of the computational model techniques described above.

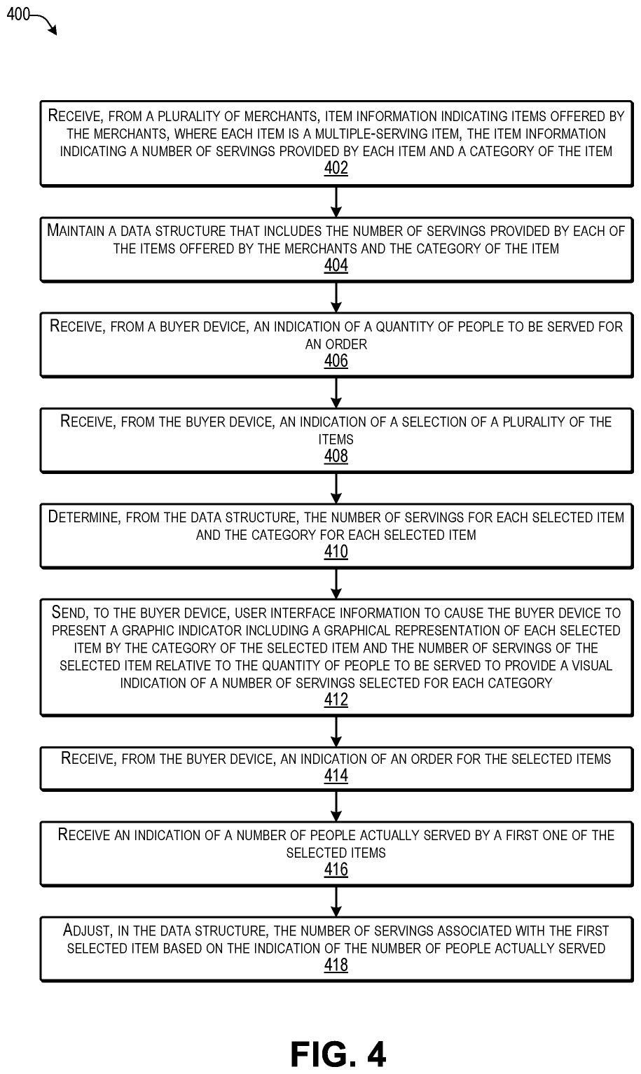

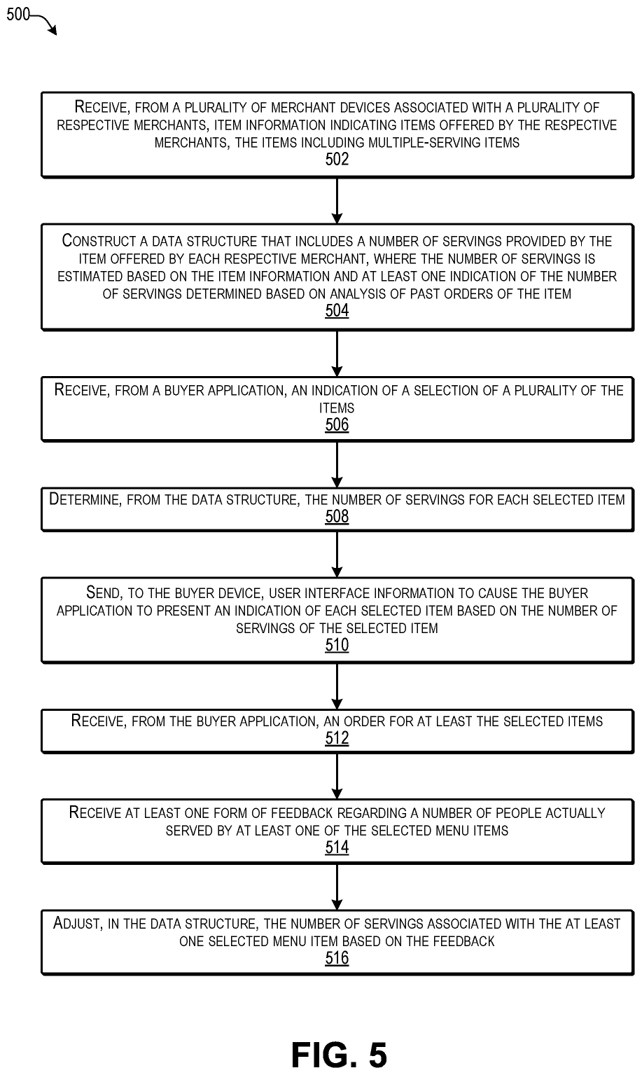

FIGS. 4-5 are flow diagrams illustrating example processes according to some implementations. The processes are illustrated as collections of blocks in logical flow diagrams, which represent a sequence of operations, some or all of which can be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. For discussion purposes, the processes are described with reference to the environments, systems and devices described in the examples herein, although the processes may be implemented in a wide variety of other environments, systems and devices.

FIG. 4 is a flow diagram illustrating an example process 400 for presenting a graphic indicator for selected items and updating the number of servings indicated for an item in a data structure according to some implementations. In some examples, the process may be executed, at least in part, by the service computing device(s) 102 or by another suitable computing device.

At 402, the computing device may receive, from a plurality of merchants, item information indicating items offered by the merchants, where each item is a multiple-serving item, the item information indicating a number of servings provided by each item, and a category of the item.

At 404, the computing device may maintain a data structure that includes the number of servings provided by each of the items offered by the merchants and the category of the item.

At 406, the computing device may receive, from a buyer device, an indication of a quantity of people to be served for an order.

At 408, the computing device may receive, from the buyer device, an indication of a selection of a plurality of the items.

At 410, the computing device may determine, from the data structure, the number of servings for each selected item and the category for each selected item.

At 412, the computing device may send, to the buyer device, user interface information to cause the buyer device to present a graphic indicator including a graphical representation of each selected item by the category of the selected item and the number of servings of the selected item relative to the quantity of people to be served to provide a visual indication of a number of servings selected for each category. For example, the graphic indicator may include at least a first indicator portion corresponding to a first category of item, and a second indicator portion corresponding to a second category of item. The first indicator portion may include a first graphic effect corresponding to a number of servings of a first selected item of the first category, and the second indicator portion may include a second graphic effect corresponding to a number of servings of a second selected item of the second category.

At 414, the computing device may receive, from the buyer device, an indication of an order for the selected items. For instance, the buyer may finish the order and authorize payment.

At 416, the computing device may receive an indication of a number of people actually served by a first one of the selected items. For instance, after the order has been received by the buyer, the computing device may receive the indication of the number of people actually service through various analysis techniques, as discussed above, e.g., with respect to FIG. 3.

At 418, the computing device may adjust, in the data structure, the number of servings associated with the first selected item based on the indication of the number of people actually served.

FIG. 5 is a flow diagram illustrating an example process 500 for adjusting a number of servings attributed to an item according to some implementations. In some examples, the process may be executed at least in part by the service computing device(s) 102 or other suitable computing device. Some of the process 500 may be combined with the process 400 in some examples.

At 502, the computing device may receive, from a plurality of merchant devices associated with a plurality of respective merchants, item information indicating items offered by the respective merchants, the items including multiple-serving items.

At 504, the computing device may construct a data structure that includes a number of servings provided by the item offered by each respective merchant, where the number of servings is estimated based on the item information and at least one indication of the number of servings determined based on analysis of past orders of the item.

At 506, the computing device may receive, from a buyer application, an indication of a selection of a plurality of the items.

At 508, the computing device may determine, from the data structure, the number of servings for each selected item.

At 510, the computing device may send, to the buyer device, user interface information to cause the buyer application to present an indication of each selected item based on the number of servings of the selected item. As one example, the graphic indicator may include at least a first indicator portion corresponding to a first category of item that may include a first graphic effect corresponding to a number of servings of a first selected item of the first category.

At 512, the computing device may receive, from the buyer application, an order for at least the selected items. For example, the buyer may finish the order and authorize payment for the order.

At 514, the computing device may receive at least one form of feedback regarding a number of people actually served by at least one of the selected menu items. For instance, after the order has been received by the buyer, the computing device may receive the indication of the number of people actually service through various analysis techniques, as discussed above, e.g., with respect to FIG. 3.

At 516, the computing device may adjust, in the data structure, the number of servings associated with the at least one selected menu item based on the feedback.

The example processes described herein are only examples of processes provided for discussion purposes. Numerous other variations will be apparent to those of skill in the art in light of the disclosure herein. Additionally, while the disclosure herein sets forth several examples of suitable frameworks, architectures and environments for executing the processes, implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art.

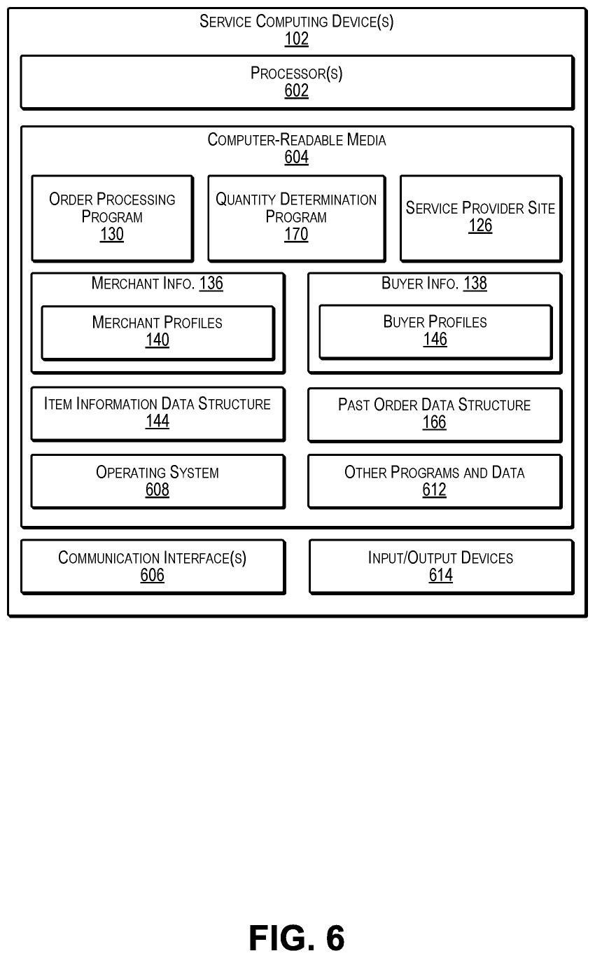

FIG. 6 illustrates select components of the service computing device(s) 102 that may be used to implement some functionality of the service described herein. The service computing device(s) 102 may include one or more servers or other types of computing devices that may be embodied in any number of ways. For instance, in the case of a server, the programs, other functional components, and data may be implemented on a single server, a cluster of servers, a server farm or data center, a cloud-hosted computing service, and so forth, although other computer architectures may additionally or alternatively be used.

Further, while the figures illustrate the components and data of the service computing device(s) 102 as being present in a single location, these components and data may alternatively be distributed across different computing devices and different locations in any manner. Consequently, the functions may be implemented by one or more service computing devices, with the various functionality described above distributed in various ways across the different computing devices. Multiple service computing devices 102 may be located together or separately, and organized, for example, as virtual servers, server banks, and/or server farms. The described functionality may be provided by the servers of a single entity or enterprise, or may be provided by the servers and/or services of multiple different entities or enterprises.

In the illustrated example, each service computing device(s) 102 may include one or more processors 602, one or more computer-readable media 604, and one or more communication interfaces 606. Each processor 602 may be a single processing unit or a number of processing units, and may include single or multiple computing units or multiple processing cores. The processor(s) 602 can be implemented as one or more microprocessors, microcomputers, microcontrollers, digital signal processors, central processing units, state machines, logic circuitries, and/or any devices that manipulate signals based on operational instructions. For instance, the processor(s) 602 may be one or more hardware processors and/or logic circuits of any suitable type specifically programmed or configured to execute the algorithms and processes described herein. The processor(s) 602 can be configured to fetch and execute computer-readable instructions stored in the computer-readable media 604, which can program the processor(s) 602 to perform the functions described herein.

The computer-readable media 604 may include volatile and nonvolatile memory and/or removable and non-removable media implemented in any type of technology for storage of information, such as computer-readable instructions, data structures, program modules, or other data. Such computer-readable media 604 may include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the service computing device(s) 102, the computer-readable media 604 may be a tangible non-transitory media to the extent that, when mentioned, non-transitory computer-readable media exclude media such as energy, carrier signals, electromagnetic waves, and signals per se.

The computer-readable media 604 may be used to store any number of functional components that are executable by the processors 602. In many implementations, these functional components comprise instructions or programs that are executable by the processors 602 and that, when executed, specifically configure the one or more processors 602 to perform the actions attributed above to the service computing device(s) 102. Functional components stored in the computer-readable media 604 may include the order processing program 130 and the quantity determination program 170. Additional functional components stored in the computer-readable media 604 may include an operating system 608 for controlling and managing various functions of the service computing device(s) 102. In addition, the computer-readable media 604 may store the service provider site 126 that may include one or more applications, data structures, images, and data as part of a web server module for hosting the service provider site 126.

Furthermore, the computer-readable media 604 may store data and data structures used for performing the operations described herein. Thus, the computer-readable media 604 may store the buyer information 138, including buyer profiles 146, the merchant information 136, including merchant profiles 140. Further, the computer-readable media 604 may include the past order data structure 166 and the item information data structure 144. The service computing device(s) 102 may also include or maintain other functional components and data not specifically shown in FIG. 6, such as other programs and data 612, which may include programs, drivers, etc., and the data used or generated by the functional components. Further, the service computing device(s) 102 may include many other logical, programmatic, and physical components, of which those described above are merely examples that are related to the discussion herein.

The communication interface(s) 606 may include one or more interfaces and hardware components for enabling communication with various other devices, such as over the network(s) 106. For example, communication interface(s) 606 may enable communication through one or more of the Internet, cable networks, cellular networks, wireless networks (e.g., Wi-Fi) and wired networks (e.g., fiber optic and Ethernet), as well as short-range communications, such as BLUETOOTH®, BLUETOOTH® low energy, and the like, as additionally enumerated elsewhere herein.

The service computing device(s) 102 may further be equipped with various input/output (I/O) devices 620. Such I/O devices 614 may include a display, various user interface controls (e.g., buttons, joystick, keyboard, mouse, touch screen, etc.), audio speakers, connection ports and so forth.

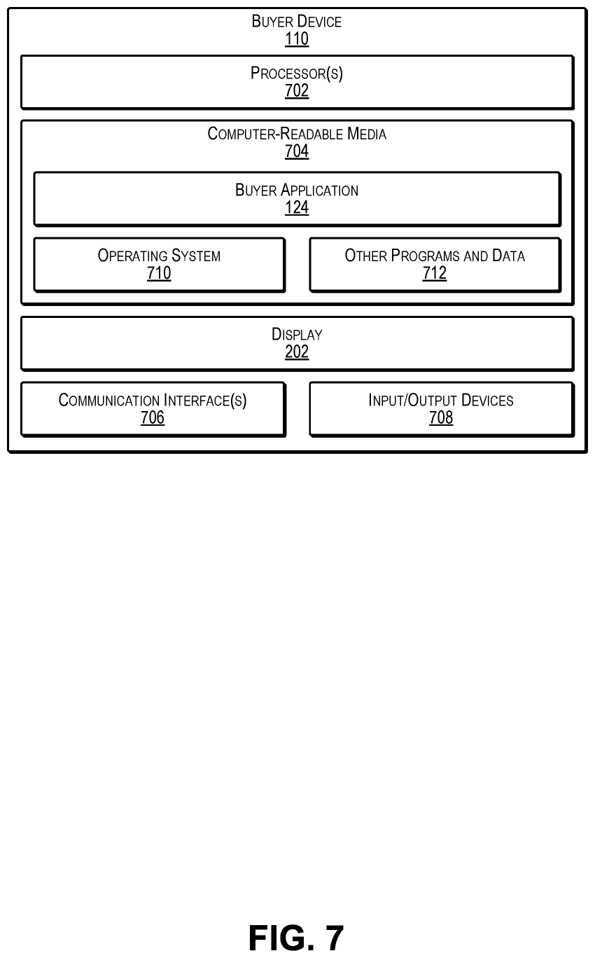

FIG. 7 illustrates select example components of the buyer device 110 that may implement the functionality described above according to some examples. The buyer device 110 may be any of a number of different types of computing devices. Some examples of the buyer device 110 may include smart phones and mobile communication devices; tablet computing devices; laptops, netbooks and other portable computers; wearable computing devices and/or body-mounted computing devices, which may include watches and augmented reality devices, such as helmets, goggles or glasses; and any other portable or otherwise mobile device capable of sending communications and performing the functions according to the techniques described herein. Further, in some examples, the buyer device 110 may be a stationary or semi-stationary computing device, such as a desktop computer or other device with computing capabilities.

In the example of FIG. 7, the buyer device 110 includes components such as at least one processor 702, one or more computer-readable media 704, one or more communication interfaces 706, and one or more input/output (I/O) devices 708. Each processor 702 may itself comprise one or more processors or processing cores. For example, the processor 702 can be implemented as one or more microprocessors, microcomputers, microcontrollers, digital signal processors, central processing units, state machines, logic circuitries, and/or any devices that manipulate signals based on operational instructions. In some cases, the processor 702 may be one or more hardware processors and/or logic circuits of any suitable type specifically programmed or configured to execute the algorithms and processes described herein. The processor 702 can be configured to fetch and execute computer-readable processor-executable instructions stored in the computer-readable media 704.

Depending on the configuration of the buyer device 110, the computer-readable media 704 may be an example of tangible non-transitory computer storage media and may include volatile and nonvolatile memory and/or removable and non-removable media implemented in any type of technology for storage of information such as computer-readable processor-executable instructions, data structures, program modules, or other data. The computer-readable media 704 may include, but is not limited to, RAM, ROM, EEPROM, flash memory, solid-state storage, magnetic disk storage, optical storage, and/or other computer-readable media technology. Further, in some cases, the buyer device 110 may access external storage, such as RAID storage systems, storage arrays, network attached storage, storage area networks, cloud storage, or any other medium that can be used to store information and that can be accessed by the processor 702 directly or through another computing device or network. Accordingly, the computer-readable media 704 may be computer storage media able to store instructions, programs, or components that may be executed by the processor 702. Further, when mentioned, non-transitory computer-readable media exclude media such as energy, carrier signals, electromagnetic waves, and signals per se.

The computer-readable media 704 may be used to store and maintain any number of functional components that are executable by the processor 702. In some implementations, these functional components comprise instructions or programs that are executable by the processor 702 and that, when executed, implement operational logic for performing the actions and services attributed above to the buyer device 110. Functional components of the buyer device 110 stored in the computer-readable media 704 may include the buyer application 124, as discussed above, which may present the buyer with one or more GUIs for placing an order. Additional functional components may include an operating system 710 for controlling and managing various functions of the buyer device 110 and for enabling basic user interactions with the buyer device 110.

In addition, the computer-readable media 704 may also store data, data structures and the like, that are used by the functional components. Depending on the type of the buyer device 110, the computer-readable media 704 may also optionally include other functional components and data, such as other programs and data 712, which may include applications, programs, drivers, etc., and the data used or generated by the functional components. Further, the buyer device 110 may include many other logical, programmatic, and physical components, of which those described are merely examples that are related to the discussion herein.

The communication interface(s) 706 may include one or more interfaces and hardware components for enabling communication with various other devices, such as over the network(s) 106 or directly. For example, communication interface(s) 706 may enable communication through one or more of the Internet, cable networks, cellular networks, wireless networks (e.g., Wi-Fi) and wired networks (e.g., fiber optic, Ethernet), as well as short-range communications such as BLUETOOTH®, BLUETOOTH® low energy, and the like, as additionally enumerated elsewhere herein.

FIG. 7 further illustrates that the buyer device 110 may include a display 202, which may employ any suitable display technology. In some examples, the display 202 may have a touch sensor to provide a touchscreen display. The buyer device 110 may further include the one or more I/O devices 708. The I/O devices 708 may include speakers, a microphone, a camera, and various user controls (e.g., buttons, a joystick, a keyboard, a keypad, etc.), a haptic output device, and so forth. Other components included in the buyer device 110 may include various types of sensors, which may include a GPS receiver able to indicate location information, as well as other sensors (not shown) such as an accelerometer, gyroscope, compass, proximity sensor, and the like. In some cases, the GPS receiver may be used by the buyer application 158 to determine or confirm a current geographic location of the buyer device 110. Additionally, or alternatively, the communication interfaces 706 may be used to determine the current location of the buyer device 110, such as based on communication with nearby cell towers, wireless access points, and the like. In some examples, the buyer application 124 may send this location information to the service computing device as an indicated delivery location for the associated buyer. Additionally, the buyer device 110 may include various other components that are not shown, examples of which include removable storage, a power source, such as a battery and power control unit, and so forth. Further, the merchant device may have components and hardware configurations similar to those of the buyer device, but with one or more different functional components.

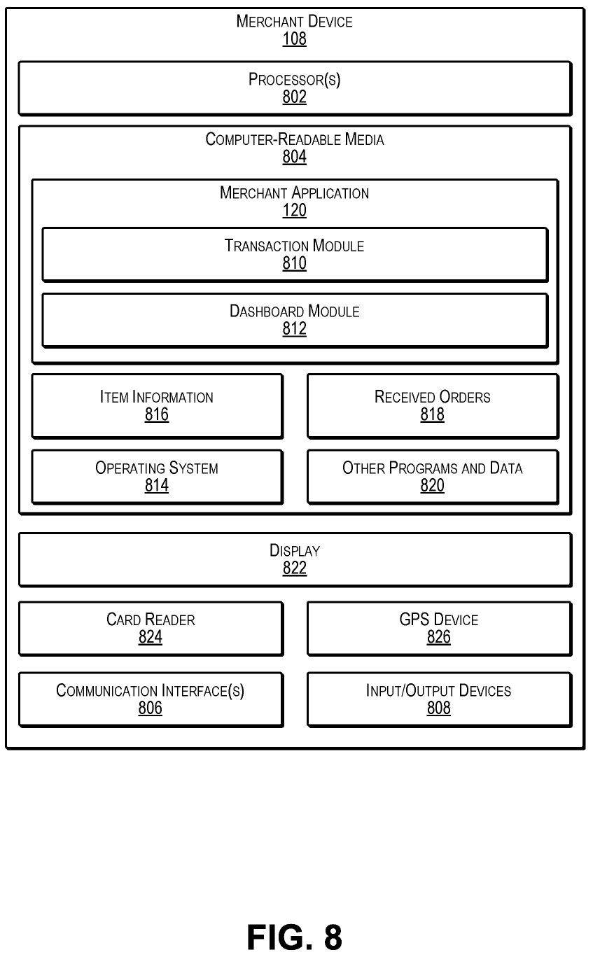

FIG. 8 illustrates select example components of an example merchant device 108 according to some implementations. The merchant device 108 may be any suitable type of computing device, e.g., portable, semi-portable, semi-stationary, or stationary. Some examples of the merchant device 108 may include tablet computing devices; smart phones and mobile communication devices; laptops, netbooks and other portable computers or semi-portable computers; desktop computing devices, terminal computing devices and other semi-stationary or stationary computing devices; dedicated register devices; wearable computing devices, or other body-mounted computing devices; augmented reality devices; or other computing devices capable of sending communications and performing the functions according to the techniques described herein.

In the illustrated example, the merchant device 108 includes at least one processor 802, one or more computer-readable media 804, one or more communication interfaces 806, and one or more input/output (I/O) devices 808. Each processor 802 may itself comprise one or more processors or processing cores. For example, the processor 802 can be implemented as one or more microprocessors, microcomputers, microcontrollers, digital signal processors, central processing units, state machines, logic circuitries, and/or any devices that manipulate signals based on operational instructions. In some cases, the processor 802 may be one or more hardware processors and/or logic circuits of any suitable type specifically programmed or otherwise configured to execute the algorithms and processes described herein. The processor 802 can be configured to fetch and execute computer-readable processor-executable instructions stored in the computer-readable media 804.

Depending on the configuration of the merchant device 108, the computer-readable media 804 may be an example of tangible non-transitory computer storage media and may include volatile and nonvolatile memory and/or removable and non-removable media implemented in any type of technology for storage of information such as computer-readable processor-executable instructions, data structures, program modules or other data. The computer-readable media 804 may include, but is not limited to, RAM, ROM, EEPROM, flash memory, solid-state storage, magnetic disk storage, optical storage, and/or other computer-readable media technology. Further, in some cases, the merchant device 108 may access external storage, such as RAID storage systems, storage arrays, network attached storage, storage area networks, cloud storage, or any other medium that can be used to store information and that can be accessed by the processor 802 directly or through another computing device or network. Accordingly, the computer-readable media 804 may be computer storage media able to store instructions, modules or components that may be executed by the processor 802. Further, when mentioned, non-transitory computer-readable media exclude media such as energy, carrier signals, electromagnetic waves, and signals per se.

The computer-readable media 804 may be used to store and maintain any number of functional components that are executable by the processor 802. In some implementations, these functional components comprise instructions or programs that are executable by the processor 802 and that, when executed, implement operational logic for performing the actions and services attributed above to the merchant device 108. Functional components of the merchant device 108 stored in the computer-readable media 804 may include the merchant application 120. In this example, the merchant application 120 includes a transaction module 810 and a dashboard module 812. For example, the transaction module 810 may present an interface, such as a payment GUI, to enable the merchant to conduct transactions, receive notifications of payments for items purchased through the service provided by the service provider, and so forth. In addition, the transaction module 810 may communicate with the service computing device 102 for processing payments and sending transaction information. Further, the dashboard module 812 may present a setup interface to enable the merchant to setup items, such as for adding new items to a menu, modifying item information for existing items, sending item information to the service computing device, and so forth. The dashboard module 812 may further enable the merchant to manage the merchant's account, the merchant's profile, merchant's preferences, view saved or new information, and the like. Additional functional components may include an operating system 814 for controlling and managing various functions of the merchant device 108 and for enabling basic user interactions with the merchant device 108.

In addition, the computer-readable media 804 may also store data, data structures, and the like, that are used by the functional components. For example, data stored by the computer-readable media 804 may include item information 816 that includes information about the items offered by the merchant, which may include a menu or other list of items currently available from the merchant, images of the items, descriptions of the items, prices of the items, number of servings for each item, category of each item, and so forth. Furthermore, the computer-readable media may also include received orders 818, which may include orders for items received from the service computing device 102 as a result of a buyer checking out a virtual cart. Depending on the type of the merchant device 108, the computer-readable media 804 may also optionally include other functional components and data, such as other modules and data 820, which may include programs, drivers, etc., and the data used or generated by the functional components. Further, the merchant device 108 may include many other logical, programmatic and physical components, of which those described are merely examples that are related to the discussion herein.

The communication interface(s) 806 may include one or more interfaces and hardware components for enabling communication with various other devices, such as over the network(s) 106 or directly. For example, communication interface(s) 806 may enable communication through one or more of the Internet, cable networks, cellular networks, wireless networks (e.g., Wi-Fi) and wired networks, as well as close-range communications such as BLUETOOTH®, BLUETOOTH® low energy, and the like, as additionally enumerated elsewhere herein.

FIG. 8 further illustrates that the merchant device 108 may include a display 822. Depending on the type of computing device used as the merchant device 108, the display 822 may employ any suitable display technology. In some examples, the display 822 may have a touch sensor associated with the display 822 to provide a touchscreen display configured to receive touch inputs for enabling interaction with a GUI presented on the display 822. Accordingly, implementations herein are not limited to any particular display technology. Alternatively, in some examples, the merchant device 108 may not include the display 822, and information may be presented by other means, such as aurally.

The merchant device 108 may further include the one or more I/O devices 808. The I/O devices 808 may include speakers, a microphone, a camera, and various user controls (e.g., buttons, a joystick, a keyboard, a keypad, etc.), a haptic output device, and so forth.

In addition, the merchant device 108 may include or may be connectable to a payment card reader 824. In some examples, the card reader 824 may plug in to a port in the merchant device 108, such as a microphone/headphone port, a data port, or other suitable port. The card reader 824 may include a read head for reading a magnetic strip of a payment card, and further may include encryption technology for encrypting the information read from the magnetic strip. Alternatively, numerous other types of card readers may be employed with the merchant device 108 herein, depending on the type and configuration of the merchant device 108.

Other components included in the merchant device 108 may include various types of sensors, which may include a GPS device 826 able to indicate location information, as well as other sensors (not shown) such as an accelerometer, gyroscope, compass, proximity sensor, barcode scanner, and the like. Additionally, the merchant device 108 may include various other components that are not shown, examples of which include removable storage, a power source, such as a battery and power control unit, and so forth.

Various instructions, methods, and techniques described herein may be considered in the general context of computer-executable instructions, such as programs stored on computer-readable media, and executed by the processor(s) herein. Generally, programs include routines, modules, objects, components, data structures, executable code, etc., for performing particular tasks or implementing particular abstract data types. These programs, and the like, may be executed as native code or may be downloaded and executed, such as in a virtual machine or other just-in-time compilation execution environment. Typically, the functionality of the programs may be combined or distributed as desired in various implementations. An implementation of these programs and techniques may be stored on computer storage media or transmitted across some form of communication media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

1. A method comprising:
receiving, by one or more processors, from at least one first device, item information for a plurality of items, the item information indicating a quantity associated with each item and a category of each item;
maintaining, by the one or more processors, a data structure that includes a quantity value associated with each of the items, respectively, of the plurality of items and the category of each of the items, the quantity value associated with each item determined based on the received item information;
sending, by the one or more processors, to a plurality of second devices, user interface information to cause respective instances of an application executing on the second devices to each present a graphic indicator including a graphical representation of selected items by respective categories of the selected items, the graphical representation further including a graphical representation of the quantity value of each of the selected items indicative of a quantity of people to be served to provide a visual indication of a number of servings selected for each category, wherein at least a first graphic indicator portion corresponds to a first category of item, and a second graphic indicator portion corresponds to a second category of item, the first graphic indicator portion including a first graphic effect corresponding to a number of servings of a first item of the first category, and the second graphic indicator portion including a second graphic effect corresponding to a number of servings of a second item of the second category, wherein the first graphic effect is visually distinguished from the second graphic effect;
receiving, over time, by the one or more processors, a plurality of indications of actual quantities for the first item, the plurality of indications including electronic communications received from the plurality of second devices regarding actual quantities of the first item;
executing, by the one or more processors, quantity analysis logic that determines whether a quantity value for the first item in the data structure is too high, too low, or accurate, the quantity analysis logic configuring the one or more processors to access information related to the received plurality of indications of the actual quantities for the first item into a machine learning computational model configured to determine, as an output, whether a plurality of past quantities associated with the first item included a surplus or a deficit of the first item, the machine learning computational model having been trained based on historic information for a plurality of past quantities associated with the first item and other items of the plurality of items;
executing, by the one or more processors, based on the output of the machine learning computational model, quantity adjustment logic to update the data structure by updating, in the data structure, based on the surplus or the deficit of the first item determined by the machine learning computational model, the quantity value associated with the first item to include an updated quantity value for the first item in the data structure, the one or more processors executing the quantity adjustment logic to update the quantity value for the first item based at least on a frequency of a respective surplus determination or deficit determination for the first item;
receiving, by the one or more processors, from a third device executing a respective instance of the application, an indication of a number of people to be served for an order and an indication of a selection of a plurality of items that includes a quantity of the first item and a quantity of the second item; and
sending, by the one or more processors, to the third device, updated user interface information to cause the respective instance of the application on the third device to present the user interface including the graphic indicator including the graphical representation of the selected items by the respective categories of the selected items, wherein the updated user interface information includes the updated quantity value, wherein at least a first graphic indicator portion includes the first item of the first category, wherein the first graphic indicator portion is presented based on the updated quantity value associated with the first item and determined by the machine learning computational model,
wherein the application on the third device is configured to update, in real time, the first graphic indicator portion and a second graphic indicator portion in the user interface on the third device each time a user selection of a corresponding item is received via the user interface on the third device and based on accessing the updated data structure via the one or more processors to provide a visual indication of progress toward a specified number of servings for each of a plurality of respective item categories corresponding to at least the first graphic indicator portion and the second graphic indicator portion.

2. The method as recited in claim 1, wherein receiving the plurality of indications of the actual quantities for the first item comprises receiving a communication from at least one second device indicating a surplus or a deficit of the first item.

3. (canceled)

4. The method as recited in claim 1, wherein the user interface on the third device further includes, for at least one graphic indicator portion, an indication of a quantity of an item of a corresponding item category to still be selected for reaching a specified quantity of servings.

5. A system comprising:
one or more processors; and
one or more computer-readable media storing instructions which, when executed by the one or more processors, cause the one or more processors to perform operations comprising:
receiving, by the one or more processors, from at least one first device, item information for a plurality of items, the item information indicating a quantity associated with each item of the plurality of items;
maintaining, by the one or more processors, a data structure that includes a quantity value associated with each of the items, respectively, of the plurality of items and a category of each item of the plurality of items, the quantity value associated with each item determined based at least on the received item information;
sending, by the one or more processors, to a plurality of second devices, user interface information to cause respective instances of an application executing on the second devices to each present a graphic indicator including a graphical representation of selected items by respective categories of the selected items, the graphical representation further including a graphical representation of the quantity value of each of the selected items indicative of a quantity of people to be served to provide a visual indication of a number of servings selected for each category, wherein at least a first graphic indicator portion corresponds to a first category of item, and a second graphic indicator portion corresponds to a second category of item, the first graphic indicator portion including a first graphic effect corresponding to a number of servings of a first item of the first category, and the second graphic indicator portion including a second graphic effect corresponding to a number of servings of a second item of the second category, wherein the first graphic effect is visually distinguished from the second graphic effect;
receiving, over time, by the one or more processors, a plurality of indications of actual quantities for the first item, the plurality of indications including electronic communications received from the plurality of second devices regarding actual quantities of the first item;
executing, by the one or more processors, quantity analysis logic that determines whether the quantity value for the first item in the data structure is too high, too low, or accurate, the quantity analysis logic configuring the one or more processors to access information related to the received plurality of indications of the actual quantities for the first item into a machine learning computational model configured to determine, as an output, whether a plurality of past quantities associated with the first item included a surplus or a deficit of the first item, the machine learning computational model having been trained based on historic information for a plurality of past quantities associated with the first item and other items of the plurality of items;
executing, by the one or more processors, based on the output of the machine learning computational model, quantity adjustment logic to update the data structure by updating, in the data structure, based on the surplus or the deficit of the first item determined by the machine learning computational model, the quantity value associated with the first item to include an updated quantity value for the first item in the data structure, the one or more processors executing the quantity adjustment logic to update the quantity value for the first item based at least on a frequency of a respective surplus determination or deficit determination for the first item;
receiving, by the one or more processors, from a third device executing a respective instance of the application, an indication of a number of people to be served for an order and an indication of a selection of a plurality of items that includes a quantity of the first item and a quantity of the second item; and
sending, by the one or more processors, to the third device, updated user interface information to cause the respective instance of the application on the third device to present the user interface including the graphic indicator including the graphical representation of the selected items by the respective categories of the selected items, wherein the updated user interface information includes the updated quantity value, wherein at least a first graphic indicator portion includes the first item of the first category, wherein the first graphic indicator portion is presented based on the updated quantity value associated with the first item and determined by the machine learning computational model,
wherein the application on the third device is configured to update, in real time, the first graphic indicator portion and a second graphic indicator portion in the user interface on the third device each time a user selection of a corresponding item is received via the user interface on the third device and based on accessing the updated data structure via the one or more processors to provide a visual indication of progress toward a specified number of servings for each of a plurality of respective item categories corresponding to at least the first graphic indicator portion and the second graphic indicator portion.

6. (canceled)

7. The system as recited in claim 5, wherein the operation of receiving the plurality of indications of the actual quantities for the first item comprises receiving a communication from at least one second device indicating a surplus or a deficit of the first item.

8. The system as recited in claim 5, wherein the operation of receiving the plurality of indications of the actual quantities for the first item comprises, based on content of the electronic communications, determining that a trend of a plurality of quantities associated with the first item indicates a surplus or a deficit of the first item.

9. (canceled)

10. The system as recited in claim 5, wherein the operation of receiving, over time, the plurality of indications of actual quantities for the first item further comprises receiving a communication from the at least one first device that indicates a quantity associated with the first item that is different from the quantity previously received from the at least one first device.

11. The system as recited in claim 5, wherein the user interface on the third device further includes, for at least one graphic indicator portion, an indication of a quantity of an item of a corresponding item category to still be selected for reaching a specified quantity of servings.

12. The system as recited in claim 11, wherein the indication of the quantity of the item is presented inside a boundary of the at least one graphic indicator portion.

13. A method comprising:
receiving, by one or more processors, from a plurality of first devices, item information for a plurality of items, the item information indicating a quantity associated with each of the items;
generating, by the one or more processors, a data structure that includes, for each item, a category of the item and a quantity value associated with the item, wherein the quantity value is based on the received item information;
sending, by the one or more processors, to a plurality of second devices, user interface information to cause respective instances of an application executing on the second devices to each present a graphic indicator including a graphical representation of selected items by respective categories of the selected items, the graphical representation further including a graphical representation of the quantity value of each of the selected items indicative of a quantity of people to be served to provide a visual indication of a number of servings selected for each category, wherein at least a first graphic indicator portion corresponds to a first category of item, and a second graphic indicator portion corresponds to a second category of item, the first graphic indicator portion including a first graphic effect corresponding to a number of servings of a first item of the first category, and the second graphic indicator portion including a second graphic effect corresponding to a number of servings of a second item of the second category, wherein the first graphic effect is visually distinguished from the second graphic effect;
receiving, over time, by the one or more processors, a plurality of indications of actual quantities for the first item, the plurality of indications including electronic communications from the plurality of second devices regarding actual quantities of the first item;
executing, by the one or more processors, quantity analysis logic that determines whether the quantity value for the first item in the data structure is too high, too low, or accurate, the quantity analysis logic configuring the one or more processors to access information related to the received plurality of indications of the actual quantities for the first item into a machine learning computational model configured to determine, as an output, whether a plurality of past quantities associated with the first item included a surplus or a deficit of the first item, the machine learning computational model having been trained based on historic information for a plurality of past quantities associated with the first item and other items of the plurality of items;
executing, by the one or more processors, based on the output of the machine learning computational model, quantity adjustment logic to update the data structure by updating, in the data structure, based on the surplus or the deficit of the first item determined by the machine learning computational model, the quantity value associated with the first item to include an updated quantity value for the first item in the data structure, the one or more processors executing the quantity adjustment logic to update the quantity value for the first item based at least on a frequency of a respective surplus determination or deficit determination for the first item;
receiving, by the one or more processors, from a third device executing a respective instance of the application, an indication of a number of people to be served for an order and an indication of a selection of a plurality of items that includes a quantity of the first item and a quantity of the second item; and
sending, by the one or more processors, to the third device, updated user interface information to cause the respective instance of the application on the third device to present the user interface including the graphic indicator including the graphical representation of the selected items by the respective categories of the selected items, wherein the updated user interface information includes the updated quantity value, wherein at least a first graphic indicator portion includes the first item of the first category, wherein the first graphic indicator portion is presented based on the updated quantity value associated with the first item and determined by the machine learning computational model,
wherein the application on the third device is configured to update, in real time, the first graphic indicator portion and a second graphic indicator portion in the user interface on the third device each time a user selection of a corresponding item is received via the user interface on the third device and based on accessing the updated data structure via the one or more processors to provide a visual indication of progress toward a specified number of servings for each of a plurality of respective item categories corresponding to at least the first graphic indicator portion and the second graphic indicator portion.

14. The method as recited in claim 13, wherein the user interface on the third device further includes, for at least one graphic indicator portion, an indication of a quantity of an item of a corresponding item category to still be selected for reaching a specified quantity of servings.

15. The method as recited in claim 13, wherein the user interface information sent to the third device causes the application on the third device to present a graphical representation of multiple items of the plurality of items arranged according to a respective category of a respective item.

16. (canceled)

17. The method as recited in claim 13, wherein receiving the plurality of indications of the actual quantities for the first item comprises receiving a communication from at least one second device indicating a surplus or a deficit of the first item.

18. The method as recited in claim 13, wherein receiving the plurality of indications of the actual quantities for the first item comprises receiving a communication from the at least one first device that indicates a quantity associated with the first item that is different from the quantity previously received from the at least one first device.

19. One or more non-transitory computer-readable media maintaining instructions that, when executed by one or more processors, program the one or more processors to perform operations comprising:
receiving, by the one or more processors, from at least one first device, item information for a plurality of items, the item information indicating a quantity associated with each item of the plurality of items;
maintaining, by the one or more processors, a data structure that includes, for each item of the plurality of items, a quantity value associated with the item and a category of each item of the plurality of items;
sending, by the one or more processors, to a plurality of second devices, user interface information to cause respective instances of an application executing on the second devices to each present a graphic indicator including a graphical representation of selected items by respective categories of the selected items, the graphical representation further including a graphical representation of the quantity value of each of the selected items indicative of a quantity of people to be served to provide a visual indication of a number of servings selected for each category, wherein at least a first graphic indicator portion corresponds to a first category of item, and a second graphic indicator portion corresponds to a second category of item, the first graphic indicator portion including a first graphic effect corresponding to a number of servings of a first item of the first category, and the second graphic indicator portion including a second graphic effect corresponding to a number of servings of a second item of the second category, wherein the first graphic effect is visually distinguished from the second graphic effect;
receiving, over time, by the one or more processors, a plurality of indications actual quantities for the first item, the plurality of indications including electronic communications received from the plurality of second devices regarding actual quantities of the first item;
executing, by the one or more processors, quantity analysis logic that determines whether the quantity value for the first item in the data structure is too high, too low, or accurate, the quantity analysis logic configuring the one or more processors to access information related to the received plurality of indications of the actual quantities for the first item into a machine learning computational model configured to determine, as an output, whether a plurality of past quantities associated with the first item included a surplus or a deficit of the first item, the machine learning computational model having been trained based on historic information for a plurality of past quantities associated with the first item and other items of the plurality of items;
executing, by the one or more processors, based on the output of the machine learning computational model, quantity adjustment logic to update the data structure by updating, in the data structure, based on the surplus or the deficit of the first item determined by the machine learning computational model, the quantity value associated with the first item to include an updated quantity value for the first item in the data structure, the one or more processors executing the quantity adjustment logic to update the quantity value for the first item based at least on a frequency of a respective surplus determination or deficit determination for the first item;
receiving, by the one or more processors, from a third device executing a respective instance of the application, an indication of a number of people to be served for an order and an indication of a selection of a plurality of items that includes a quantity of the first item and a quantity of the second item; and
sending, by the one or more processors, to the third device, updated user interface information to cause the respective instance of the application on the third device to present the user interface including the graphic indicator including the graphical representation of the selected items by the respective categories of the selected items, wherein the updated user interface information includes the updated quantity value, wherein at least a first graphic indicator portion includes the first item of the first category, wherein the first graphic indicator portion is presented based on the updated quantity value associated with the first item and determined by the machine learning computational model,
wherein the application on the third device is configured to update, in real time, the first graphic indicator portion and a second graphic indicator portion in the user interface on the third device each time a user selection of a corresponding item is received via the user interface on the third device and based on accessing the updated data structure via the one or more processors to provide a visual indication of progress toward a specified number of servings for each of a plurality of respective item categories corresponding to at least the first graphic indicator portion and the second graphic indicator portion.

20. The one or more non-transitory computer-readable media as recited in claim 19, wherein the user interface on the third device further includes, for at least one graphic indicator portion, an indication of a quantity of an item of a corresponding item category to still be selected for reaching a specified quantity of servings.

21. The one or more non-transitory computer-readable media as recited in claim 19, wherein the user interface information causes the application on the third device to present a graphical representation of multiple items of the plurality of items arranged according to a respective category of a respective item.

22. (canceled)

23. The one or more non-transitory computer-readable media as recited in claim 19, wherein receiving the plurality of indications of the actual quantities for the first item comprises, based on content of the electronic communications, determining that a trend of a plurality of quantities associated with the first item indicates a surplus or a deficit of the first item.

24. The one or more non-transitory computer-readable media as recited in claim 19, wherein receiving the plurality of indications of the actual quantities for the first item comprises receiving a communication from the at least one first device that indicates a quantity associated with the first item that is different from the quantity previously received from the at least one first device.
